(19) United States
(12) Patent Application Publication
(10) Pub. No.: US 2024/0107613 A1
(43) Pub. Date: Mar. 28, 2024

(54) POWER SAVING OPTIMIZATION FOR HIGH-MOBILITY SCENARIOS

(71) Applicant: Apple Inc., Cupertino, CA (US)

(72) Inventors: Bingyin Cui, Shanghai (CN); Cheng Li, Shanghai (CN); Han Pu, Shanghai (CN); Lele Cui, Beijing (CN); Muthukumaran Dhanapal, San Diego, CA (US)

(21) Appl. No.: 18/371,771

(22) Filed: Sep. 22, 2023

Related U.S. Application Data
(60) Provisional application No. 63/409,390, filed on Sep. 23, 2022.

(51) Int. Cl. H04W 76/20; H04W 28/082

(52) U.S. Cl. CPC H04W 76/20; H04W 28/082

(57) ABSTRACT

Disclosed are methods, systems, and computer-readable medium to perform operations including: determining that a user equipment (UE) is connected to a cell of a network using a connection in a standalone (SA) mode; based on determining a bandwidth part (BWP) of the connection, accessing a physical cell identifier (PCI) list associated with the UE for a time period; based on the number of PCI values in the list and a duration of the time period, assigning, to a BWP switch timer, a timeout value; initiating the BWP switch timer; and in response to determining that the handover of the UE to the different cell of the network occurs prior to the BWP switch timer reaching the timeout value, causing the UE to switch to a LTE mode.

### CLAIM OF PRIORITY

This application claims priority under 35 U.S.C. §119(e) to U.S. Patent Application Ser. No. 63/409,390 filed on Sep. 23, 2022, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

To get high throughput 5G NR networks, a frequency bandwidth is set that is much higher than the frequencies used for LTE. As a result, a user equipment (UE) consumes additional power. The network can be configured to switch between bandwidth parts (BWP) to save power for the UE. The network configures multiple BWP for a given UE. When the UE requires a large throughput, the UE uses a large BWP. When the UE does not require a large throughput, the UE is switched to a small BWP to save power.

A UE also can use a smart data mode (SDM) to save power. The UE is configured to automatically switch between a 5G standalone (SA) mode and an LTE mode according to a service type. The UE stays in the SA mode for high throughput scenarios. The UE deprioritizes SA mode and switches to LTE if not in a high-throughput scenario. A NR L1 measurement can be pruned to save power. The UE reprioritizes from LTE to SA when a high throughput scenario is again required.

### SUMMARY

A user equipment (UE) is configured to operate in one of a 5G standalone (SA) mode or a non-standalone (NSA), LTE mode. When operating in the SA mode, the UE is configured to use the 5G NR network (NW) for both of transmission and reception of control information (e.g., the control plane) and user data (e.g., the user plane). When operating in the LTE mode, the UE is configured to use the LTE network for transmission and reception of control information and user data. The UE is configured to switch between the SA mode and the LTE mode. In some implementations, the UE switches from the SA mode to the LTE mode to save power.

To save the power, UE deprioritizes from the SA mode to the LTE-only mode. The UE switches when there is no high throughput and while a Smart Data Mode (SDM) is on. In the LTE-only mode (LTE mode), the 5G L1 measurement is disabled (e.g., pruned, saving power. Power saving can occur because a bandwidth of 5G configured transmissions is larger (e.g., 100 MHz/60 MHz . . . ) relative to a bandwidth LTE (e.g., 20 MHz/10 MHz/5 MHz).

Generally, the UE operates in accordance with a network configuration. The UE does not activate the SDM until a network feature bandwidth part switch is not detected by the UE. The UE initiates an internal bandwidth part switch timer to detect the network feature bandwidth part switch, as subsequently described herein. The bandwidth part switch timer initiates when the UE is not using a large throughput. The UE resets the bandwidth part timer when a physical cell identifier of the network changes. Conventionally, the UE does not fall back from the SA mode to the LTE mode until the bandwidth part switch timer expires.

The UE may experience a high-mobility scenario. A high-mobility scenario includes a scenario in which the UE is moving in the network such that the UE moves among different cells of the network at above a threshold frequency. When switching between cells of the network, the UE can be prevented from switching from SA mode to LTE mode, because the bandwidth part timer is rapidly reset. The UE is therefore prevented from switching from the SA mode to the LTE only mode to save power.

The UE may experience a load balancing scenario. In this scenario, the UE may be switched between two BWPs based on throughput requirements and small BPW active UE capacity. In this scenario, the network switches the UE from a first bandwidth part (BWP), such as a large BWP, to a second BWP, such as a small BWP, when the UE is not using a high throughput to distribute bandwidth use of connected devices in a network in a cell of the network. The network can switch the UE back to the large BWP when the capacity of the small BWP is exceeded. BWP generally includes a set of physical resource blocks (PRBs) for a given carrier. These resource blocks (RBs) are selected from a contiguous subset of the common resource blocks for a given numerology.

The systems and processes described herein are configured for optimizing the UE for switching between the SA mode and the LTE mode when the UE is in a high-mobility scenario. In a first process, the UE is configured to optimize a switch timer when the UE detects that the UE is in a high-mobility scenario. In a second process, the UE is configured to optimize a switch from SA mode to LTE mode when the UE detects that the UE is in a high-mobility scenario. In a third process, the UE determines that the UE is in a load-balancing mode. The UE is configured to optimize the switch between SA mode and LTE mode when in the load-balancing scenario. For each of the high-mobility scenario and the load balancing scenario, the UE is configured to determine that the scenario is applicable by application of a statistical model. The statistical model describes how often the UE has switched among cells of the network over a period of time. The UE uses data from a switch timer and a physical cell identifier (PCI) switch counter as inputs for the statistical model. The UE is configured to determine whether to switch between the SA mode and the LTE mode based on the statistical model.

The one or more advantages described herein can be enabled by the embodiments of the systems and processes described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, in accordance with some embodiments.

FIG. 2 shows a flow diagram illustrating a process for SA switching by a UE.

FIG. 3A shows a flow diagram illustrating a process for optimizing a SA switch timer by a UE.

FIG. 3B shows a flow diagram illustrating a process for optimizing a SA switch timer by a UE.

FIG. 4 shows a flow diagram illustrating a process for switching from a SA mode to an LTE mode in response to detection of a high-mobility scenario by a UE.

FIG. 5A shows example results of SA switching by a UE in accordance with the process of FIG. 3A or 3B.

FIG. 5B shows example results of SA switching by a UE in accordance with the process of FIG. 4.

FIG. 6 shows a diagram illustrating SA switching by a UE for BWP load balancing.

FIG. 7A shows a flow diagram illustrating a process for SA switching by a UE for BWP load balancing.

FIG. 7B shows a flow diagram illustrating a process for SA switching by a UE for BWP load balancing.

FIG. 8 illustrates a user equipment (UE), in accordance with some embodiments.

FIG. 9 illustrates an access node, in accordance with some embodiments.

### DETAILED DESCRIPTION

A user equipment (UE) is configured to operate in one of a 5G standalone (SA) mode or an LTE mode. When operating in the SA mode, the UE is configured to use the 5G NR network (NW) for both of transmission and reception of control information (e.g., the control plane) and user data (e.g., the user plane). More specifically, for SA operation, the UE uses the 5G network and NR frequencies (e.g., FR1, FR2, etc.) for the control plane and user data. When operating in the LTE mode, the UE is configured to use the LTE network for transmission and reception of control information, and user data. More specifically, when operating in the LTE mode, the UE is configured to use 4G LTE infrastructure and protocols for control functions and user data.

The UE is configured to switch between the SA mode and the LTE mode. In some implementations, the UE switches from the SA mode to the LTE mode to save power. Switching from SA mode to LTE mode is also called deprioritization SA and fall back to LTE. The UE may determine that a switch to LTE mode is desirable because throughput requirements for the UE are satisfied by the lower throughput of LTE mode.

The UE may experience a high-mobility scenario. A high-mobility scenario includes a scenario in which the UE is moving in the network such that the UE moves among different cells of the network at above a threshold frequency. The UE does not stay within a cell for longer than a given period of time. This can occur if the UE is moving quickly in a vehicle such as a car or train, or if the UE is moving in a densely populated area. For example, on a high speed train, the UE may only be in a given cell for a few seconds (e.g., less than 15 seconds). In another example, the UE may be in a border zone in which the UE frequently switches between two neighboring serving cells (e.g., a ping pong zone). In some implementations, the UE may be rapidly switching between large BWP and small BWP (e.g., a load balancing zone).

The UE may be prevented from switching from SA mode to the LTE mode in high-mobility scenarios for several reasons. The UE does not switch from the SA mode to the LTE mode when the NW has already switched the UE from a large BWP to a small BWP. The smart data mode (SDM) depriority does not occur until a BWP switch timer expires in the 5G SA mode for the UE. Generally, the BWP switch timer default value is 15 seconds. The UE resets the switch timer to zero responsive to a cell hand over. The UE detects a cell handover when the physical cell identifier (PCI) value received is changed. This occurs in situations in which the UE is in high mobility in a densely populated area (e.g., a high mobility case in a city). The

UE may be prevented from switching between SA and LTE when moving quickly, such as when on a high-speed train. The UE may be prevented from switching between SA and LTE when near a cell border, such as a cell ping pong area, in which the UE switches between large BWP (e.g., BWP ID 1) and small BWP because of overloading on BWP ID 2 (the small BWP). Additionally, the UE may be prevented from switching from SA to LTE when the PCI changes more than a threshold frequency because the switch timer never expires. As a result of staying in the SA mode, the UE power consumption is unnecessarily higher than if the UE switches to the LTE mode. Specifically, to save UE power, the network configures multiple bandwidth parts (BWPs) for the UE. The UE switches to a small BWP when the UE is not using high throughput. The UE switches to the large or high BWP when the UE is using high throughput.

To overcome these technical hurdles, the UE is configured to detect that a high-mobility scenario is occurring and change the criteria for switching to the LTE mode from the SA mode in those high-mobility scenarios. The UE is configured to optimize the procedure for deprioritization of the UE from the SA mode to the LTE mode. The UE is configured to optimize the BWP switch timer. The BWP switch timer is adaptive when the UE is in a high-mobility scenario. The UE changes the length of the BWP timer based on statistics for PCI changes or BWP timer reset statistics over a given period of time. In another example, the UE switches to LTE mode and operates using the LTE network once a high-mobility scenario is detected.

The UE can detect that the UE is in a high-mobility scenario or in a load-balancing scenario in the following cases. For example, the UE can be moving quickly in a city or densely populated area. In some implementations, the UE may be on a high speed train or other fast-moving vehicle. In some implementations, the UE may be near a BWP ping pong area. As a result of these scenarios, the UE is configured to adjust the process for switching from SA mode to LTE mode. This because the UE stay on a single PCI always shorter than a given time period (e.g., 7 seconds), but the BWP with timer is fixed at a longer time period (e.g., 15 seconds). In another example, the PCI for the UE changes too frequently and causes the SA de-priority procedure to fail at handover ping-pong zones. Frequent BWP switching also causes UE power consumption to increase. The processes described herein address these scenarios to reduce UE power consumption and enable SA mode to LTE mode switching in high-mobility scenarios.

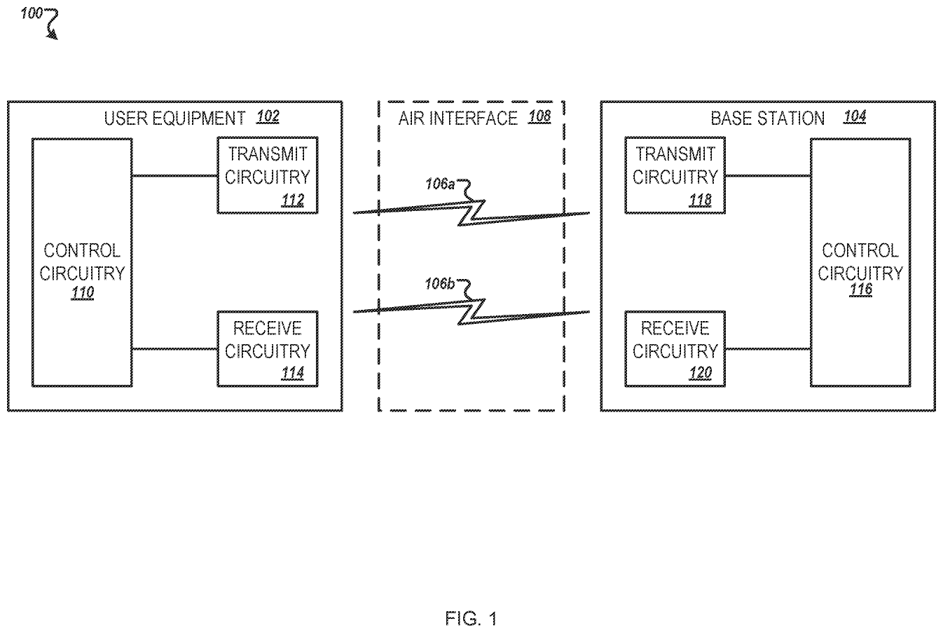

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels includes of a plurality of downlink sub-frames. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

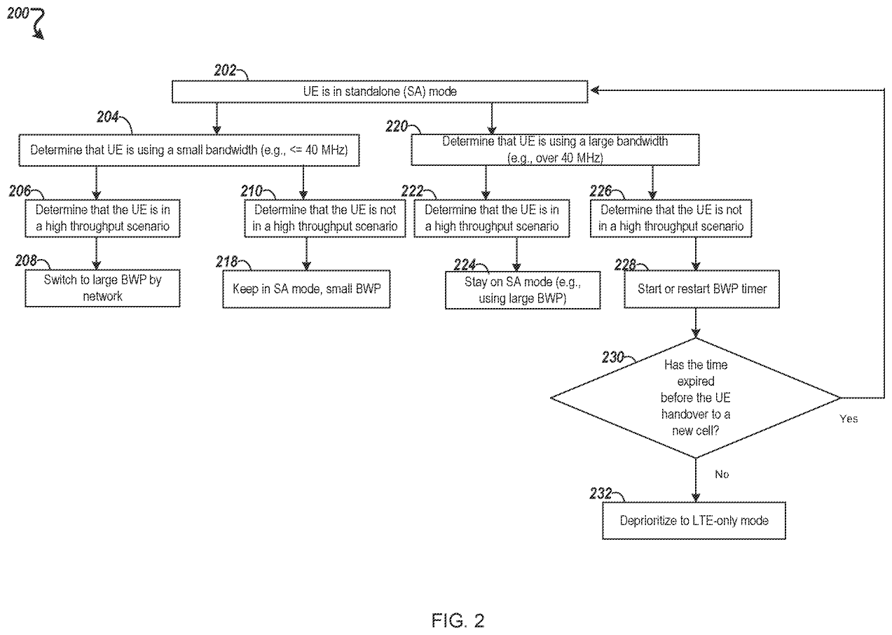

FIG. 2 shows a flow diagram illustrating a process 200 for SA switching by a UE (such as UE 102 of FIG. 1). The UE operation is based on the state of the UE. If the UE is being used by a user, the UE is configured to determine if data use by the user is a low enough throughput that the UE can switch to the LTE mode without adversely affecting performance of the UE.

Generally, the UE determines whether to change from the SA mode to the LTE mode based on current bandwidth. In a first case, the UE determines that the 5G NR bandwidth is less than or equal to a particular threshold. For example, the bandwidth threshold can be 20 megahertz (MHz), 25 MHz . . . 40 MHz, or similar values. If the bandwidth is less than or equal to the threshold value, the UE remains (206) in the SA mode, since the working bandwidth is similar as LTE. In a second case, if the UE determines that the 5G NR bandwidth is above the threshold value (e.g., 40 MHz) and doesn't have high throughput using, the UE switches to the LTE mode and operates using the LTE network (e.g., base station 104 of FIG. 1).

In a first case, the UE determines that the FR1 or FR2 bandwidth is less than or equal to a particular threshold. For example, the bandwidth threshold can be 20 megahertz (MHz), 25 MHz . . . 40 MHz, or similar values. If the bandwidth is less than or equal to the threshold value, and the UE doesn't have a high throughput using, the UE remains in the SA mode.

In a second case, the UE determines that the 5G NR bandwidth is above the threshold value (e.g., 40 MHz). The UE determines whether the UE is in a high-confidence or low-confidence scenario. The confidence level of the UE is a result of a statistical testing of performance requirements with throughput. A signal or a combination of signals is offered to the RX port(s) of the receiver of the UE. An ability of the receiver to demodulate/decode this signal is verified by measuring the throughput by the UE. The UE is known as a device under test (DUT). The confidence level is determined by a percentage of the maximum throughout that is achieved by the UE. If the UE determines that the UE is in a high-throughput, high-confidence scenario, the UE remains in the SA mode. If the UE determines that the UE is in a high-throughput, low confidence mode, the UE initiates a switch timer. The UE determines whether a BWP switch occurs from the network within a threshold period of time. In some implementations, the threshold period is static and can be vendor specific (e.g., accessed in a lookup table). In some implementations, the threshold period is adjustable. For example, the bandwidth timer can be 15 seconds, 10 seconds, 5 seconds, or another length of time. If the UE determines that the switch timer exceeds the threshold, the UE switches to the LTE mode and operates using the LTE network (e.g., base station 104 of FIG. 1).

For the process 200, describing a baseline operation of the UE, the UE operates as now described. The UE detects that the network is load balancing the UE on the network. The UE is operating (202) in the SA mode. The UE is configured to determine whether to change from the SA mode to the LTE mode based on current bandwidth. In a first case, the UE determines (204) that the FR1 or FR2 bandwidth is less than or equal to a particular threshold. For example, the bandwidth threshold can be 20 megahertz (MHz), 25 MHz . . . 40 MHz, or similar values. If the bandwidth is less than or equal to the threshold value, the UE determines whether the UE is operating in a high throughput mode or a low throughput mode. If the UE determines (206) that the UE operating in a high throughput mode, the UE is configured to perform (208) a BWP switch to the large BWP. If the UE determines (210) that the UE is operating in a low throughput mode, the UE is configured to keep the UE in the SA mode (218) and use the small BWP. But if the UE determines (210) that the UE is operating in a low throughput mode, the UE is configured to perform a BWP switch to the large BWP, as instructed by the network for load balancing. The small BWP threshold (40 MHz) is a configurable value. In this example, the default is 40 MHz. Generally, the level for high throughput use is defined by a service type and data usage quantity and is case-specific.

In some implementations, the UE determines (220) that the UE is operating using the large BWP. For example, the UE determines, in the SA mode, that the FR1/FR2 bandwidth is above the threshold value (e.g., 40 MHz). If the UE determines (222) that the UE operating in a high throughput mode, the UE remains (224) in the SA mode using the large BWP. If the UE determines (226) that the UE is not using a high-throughput service or is not in a high-throughput mode, the UE is configured to start or restart (228) a BWP switch timer (e.g., at 15 seconds). The UE determines (230) whether to stay in the SA mode or switch to the LTE mode. If the network switches the UE to the small BWP before the UE switch timer expires or the UE is handed over to a new cell by the network, the UE does not switch to the LTE network and instead stays on the SA mode. The UE determines throughput scenario again (e.g., by returning to step 202). If the BWP switch timer expires, the UE switches (232) to LTE mode and uses the LTE network.

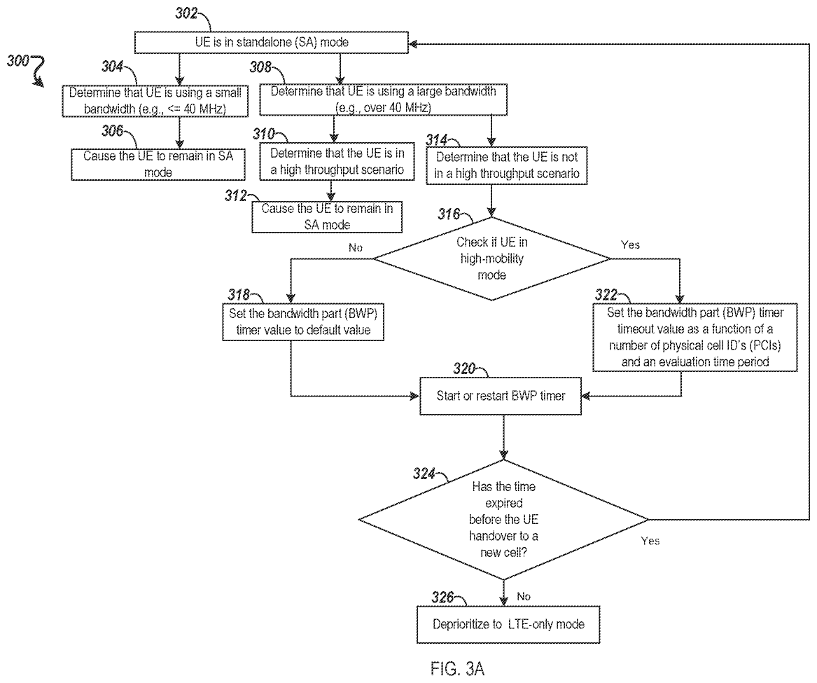

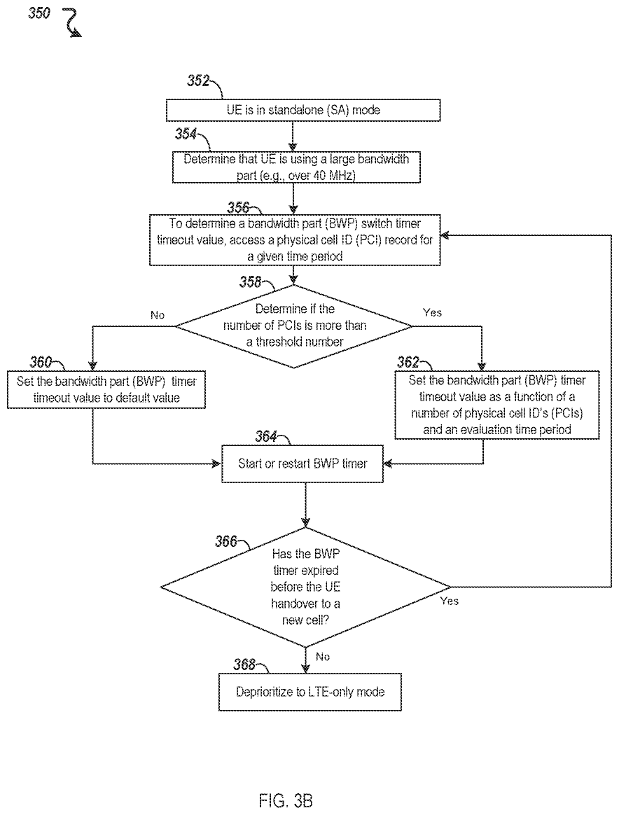

FIG. 3A shows a flow diagram illustrating a process 300 for optimizing a SA switch timer of a UE (e.g., UE 102 of FIG. 1). In process 300, the UE is configured to optimize a SA de-priority procedure when the UE detects that the UE is in a high-mobility scenario. When the UE detects a high-mobility scenario is occurring, the UE enters a high-mobility mode for performing process 300. For the process 300, the UE is configured to optimize a BWP switch timer of the UE. The BWP switch time can be set at an adaptive or static value when the UE is in a high-mobility mode. When in a static mode, the value is determined based on global statistics of many UE devices. The UE has a set switch timer that ensures that the UE switches to the LTE mode from the SA mode during high-mobility scenarios. For example, the timer may be set to 3 seconds or 5 seconds instead of the typical 15 seconds.

In an adaptive mode, the UE is configured to set the switch timer based on data gathered over a time period in which the UE has detected high mobility of the UE. For example, the UE detects that the UE is in a high-mobility scenario because the UE experiences a frequently changing PCI. In some implementations, the UE uses other data for this determination, such as global positioning system (GPS) data. The UE can monitor PCI values over a period of time, such as 40 seconds. In some implementations, the period of time is less than 40 seconds (e.g., 0-40 seconds). In some implementations, the period is longer than 40 seconds. The UE sets a value for the BWP switch timer based on the PCI values and/or BWP switch timer reset statistics during the measurement time period. The value of the switch timer is set such that the timer will expire before the PCI changes for a UE. The time can be set to the average length of time spent in a given cell by the UE during a high-mobility scenario. For example, to set the timer value, the UE receives data from a centralized unit high-speed train log. In this example, the UE determines that the PCI value changed 16 times in 40 seconds. The UE optimizes the BWP switch timer to 3 seconds.

The UE performs process 300 by determining (302) if the UE is staying on the SA mode or is considering a switch to LTE mode. The UE is configured to determine whether to change from the SA mode to the LTE mode based on current bandwidth. In a first case, the UE determines (304) that bandwidth (e.g., for FR1 or FR2), is less than or equal to a particular threshold. For example, the bandwidth threshold can be 20 megahertz (MHz), 25 MHz . . . 40 MHz, or similar values. If the bandwidth is less than or equal to the threshold value and the UE determines that the UE is not using a high throughput, the UE remains (306) in the SA mode. In other words, when the UE determines that the UE is operating in a high throughput mode, the network switches the UE to the large BWP. In a second case, the UE determines (308) that the FR1/FR2 bandwidth is above the threshold value (e.g., 40 MHz). The UE then determines whether the UE is in a high-throughput or low-throughput scenario. If the UE determines (312) that the UE is in a high-throughput scenario, the UE remains (312) in the SA mode. If the UE determines (314) that the UE is in a low-throughput scenario, the UE checks a mobility scenario of the UE. The UE determines (316) whether the UE is in a high-mobility scenario, as previously described. If the UE is in a high-mobility scenario, the UE switches to a high-mobility mode. In the high-mobility mode, the UE sets (322) a BWP switch timer as a function of an evaluation period (T) and a number (N) of detected PCI values during the time period. The UE sets the value (X) of the BWP switch timer in seconds based on the values of T and N. As previously described, the value of X can be based on values of both T and N. For example, the value of X can be a ratio of T and N. Specially, the value of X can be as follows: X=roundup(T/N), where roundup(T/N) is the ratio of T:N, rounded up. The UE transitions to a high-mobility mode (also called a high speed mode) if N exceeds a threshold value (e.g., 3) during the time period T (e.g., 40 seconds). This is in contrast to simply starting a static timer when the large BWP is detected and when the UE is not using high throughput. In that case, if the network switches the UE to the small BWP before the UE switch timer expires or the UE is handed over to a new cell by the network, the UE does not switch to the LTE network. However, the UE does not adjust the switch timer. If in a high-mobility scenario with a nominal switch timer value, the timer will never expire, and the UE will not switch to the LTE mode. In the present process 300, the timer value is changed for the high-mobility mode. The UE starts (320) the timer with the updated value. If the UE is not in the high-mobility mode, the UE sets (318) the BWP switch timer to the nominal value (e.g., 15 seconds). Table 1 shows example values for N, T, and X.

TABLE 1
Example timer length values X in high-mobility scenarios.

| | Number of | Time period | Switch timer |
|---|---|---|---|
| | Different PCI | length | length in |
| UE Mobility Mode | values (N) | in seconds (T) | seconds (X) |
| Non-High Speed Mode | 3 | 40 | 15 |
| High Speed Mode | 4 | 40 | 10 |
| High Speed Mode | 6 | 40 | 7 |
| High Speed Mode | 8 | 40 | 5 |
| High Speed Mode | 6 | 30 | 5 |

The switch timer counts down once the UE sets the timer to the initial value. The UE determines (324) whether to stay in the SA mode or switch to the LTE mode. If the network switches the to the small BWP by the network before the UE switch timer expires or the UE is handed to a new cell by the network, the UE does not switch to the LTE network and instead stays on the SA mode. The UE can either determine a new updated timer value (e.g., by returning to step 302) or reset the timer to the present set point value (e.g., by returning to step 320). In some implementations, the UE resets the timer with a new time based on the trailing 40 second period of a high-mobility mode. When the timer expires, the UE switches (326) to the LTE mode.

FIG. 3B shows a flow diagram illustrating a process 350 for optimizing a SA switch timer by a UE (e.g., UE 102 of FIG. 1). The UE is configured (352) to be in SA mode. The process 350 includes determining (354) that the UE is on a large BWP (e.g., over 40 MHz). The BWP size threshold can be 20 MHz, 40 MHz, 60 MHz, or other values between or similar to these examples.

The process 350 includes accessing (356) a PCI record for the UE for a given time period T, such as for the last 40 seconds. The timeout value for the BWP switch timer is to be set based on the number of different PCIs are in the PCI record for the UE during the time period. The process 350 includes determining (358) if the number of different PCIs in the PCI record of the UE is greater than the threshold number. In some implementations, the threshold number is predetermined (e.g., a static, preset value). In some implementations, the threshold number is based on network activity of the UE or one or more other UEs over several time periods of length T or of variable length. The UE determines, from the number of PCIs in the record and the length of the time period, how long the UE was associated with each cell of the PCI record. If the number of PCIs satisfies (e.g., exceeds or equals) the threshold number, the UE is configured to set (362) the BWP timer timeout value as a function of the time period length T and the number N of different PCIs in the record. In some implementations, the function is a ratio of N:T. If the number N does not satisfy the threshold number, the UE is configured to set (360) the BWP timer timeout value to a preset default value (e.g., 15 seconds).

The process 350 includes starting or restarting the BWP timer, once the BWP timer timeout value is set. The BWP timer increments over time. The UE is configured to determine (366) if the BWP timer has expired before UE handover to a new cell. If the timer has expired, the UE is configured to again access (356) the PCI record to determine an updated BWP switch timer timeout value. If UE handover does not occur and the BWP timer reaches the timeout value (e.g., expires), the UE is configured to deprioritize (368) to LTE, or switch to LTE mode.

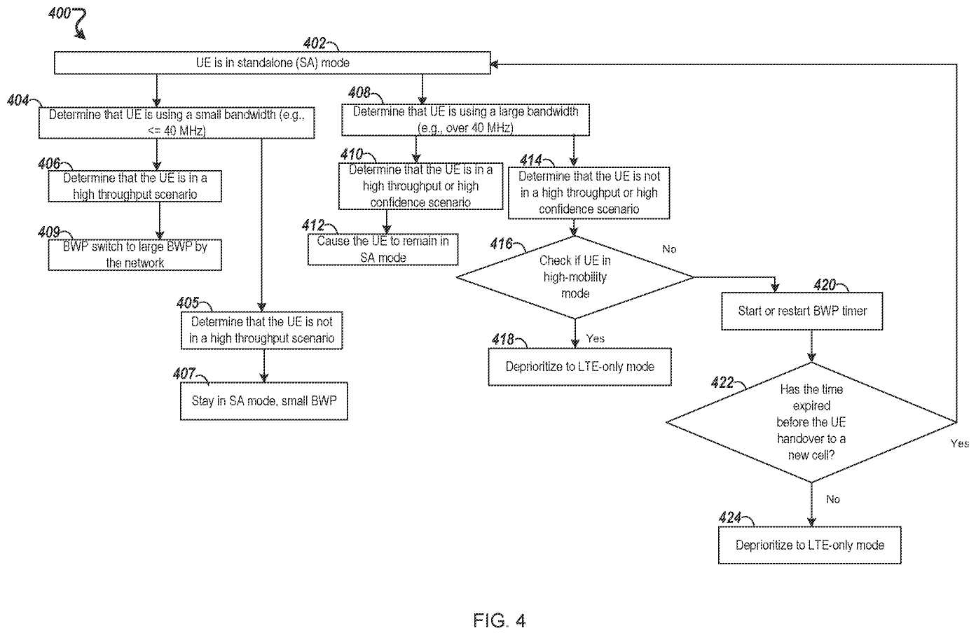

FIG. 4 shows a flow diagram illustrating a process 400 for switching from a SA mode to an LTE mode in response to detection of a high-mobility scenario by a UE (e.g., UE 102 of FIG. 1). When the UE detects a high-mobility scenario is occurring, the UE enters a high-mobility mode for performing process 400. For the process 400, the UE is configured to eliminate a BWP switch timer of the UE or set the timer value to 0. For process 400, the UE is configured to switch to LTE mode using the LTE network when a high-mobility scenario is detected.

The UE performs process 400 by determining (402) if the UE is staying on the SA mode or is considering a switch to LTE mode. The UE is configured to determine whether to change from the SA mode to the LTE mode based on current bandwidth. In a first case, the UE determines (404) that the FR1 or FR2 bandwidth is less than or equal to a particular threshold. For example, the bandwidth threshold can be 20 megahertz (MHz), 25 MHz . . . 40 MHz, or similar values. If the bandwidth is less than or equal to the threshold value, the UE is configured to determine (406) if the UE is operating in a high throughput scenario. If the UE is operating in a high throughput scenario, the network switches (409) the UE to a large BWP. If the UE is not operating in a high throughput scenario (405), the UE stays (407) in the SA mode and uses a small BWP.

In a second case, the UE determines (408) that the FR1/FR2 bandwidth is above the threshold value (e.g., 40 MHz). The UE determines whether the UE is in a high-throughput or low-throughput scenario. If the UE determines (410) that the UE is in a high-throughput scenario, the UE remains (412) in the SA mode. If the UE determines (414) that the UE is in a low-throughput scenario, the UE checks a mobility scenario of the UE. The UE determines (416) whether the UE is in a high-mobility scenario, as previously described. If the UE is in a high-mobility scenario, the UE switches to LTE mode using the LTE network.

The UE transitions to a high-mobility mode (also called a high speed mode) if a PCI value for the UE changes more than a threshold number of times (e.g., 3) during a monitoring time period T (e.g., 40 seconds). This is in contrast to simply starting a static timer when the large BWP is detected and when the UE is not using high throughput. The UE changes the BWP switch timer value to zero for the high-mobility mode. Therefore, when the UE detects a high-mobility scenario is occurring and enters the high-mobility mode, the UE immediately switches (418) to LTE mode. If the UE is not in the high-mobility mode, the UE sets (420) the BWP switch timer to the nominal value (e.g., 15 seconds). The switch timer counts down once the UE sets the timer to the initial value. The UE determines (422) whether to stay in the SA mode or switch to the LTE mode. If the network switches the to the small BWP by the network before the UE switch timer expires or the UE is handed to a new cell by the network, the UE does not switch to the LTE network and instead stays on the SA mode. The UE tests for a high-mobility scenario again (e.g., by returning to step 402 or step 416). If the BWP switch timer expires, the UE switches (424) to LTE mode and uses the LTE network.

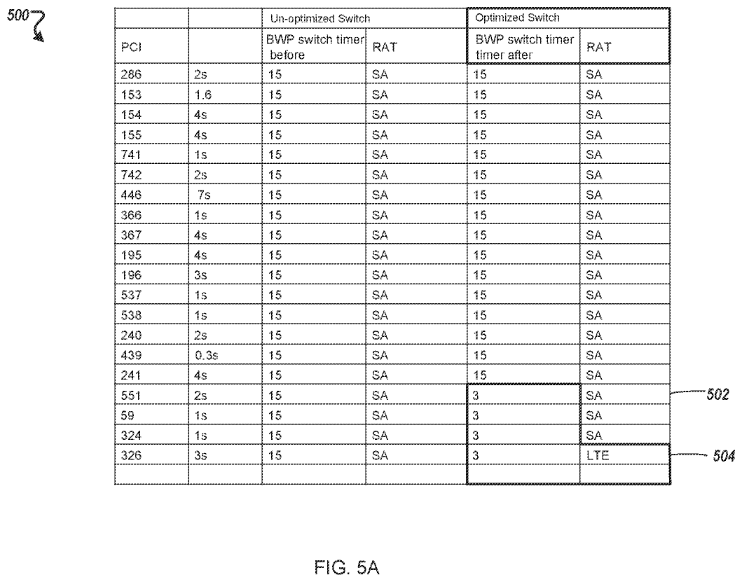

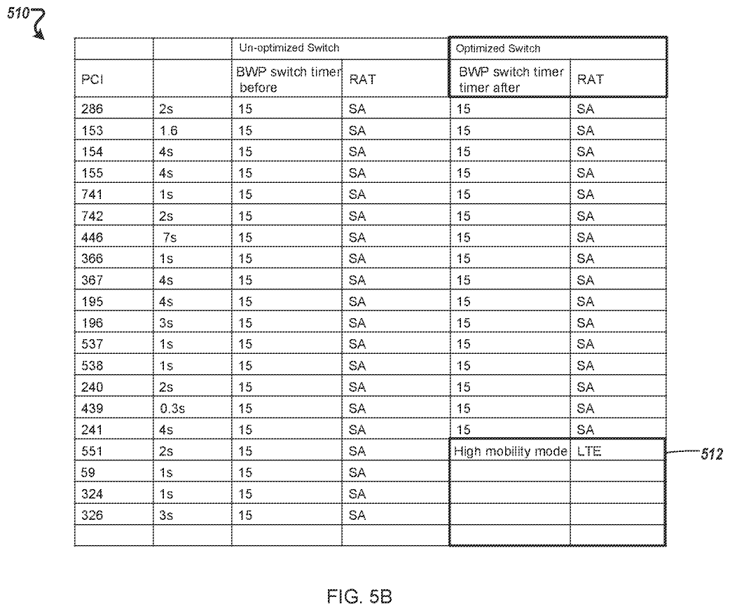

FIG. 5A shows example results 500 of SA switching by a UE in accordance with the process 300 of FIG. 3A or 3B. Results 500 show a time period of over 40 seconds. For each PCI value received by the UE, the time period associated with that physical cell is also shown. After about 40 seconds pass, the UE determines at time corresponding to entry 502 that the number of changes for the PCI value indicate that a high-mobility mode is occurring. The BWP timer value is reset from 15 seconds to 3 seconds because the PCI value changed more than 13 times during the monitoring period. The UE uses the adjusted switch timer value of 3 in high-mobility mode. At time corresponding to entry 504, the UE remains in a same cell for at least 3 seconds. The BWP switch timer expires and the UE switches to LTE mode using LTE network.

FIG. 5B shows example results 510 of SA switching by a UE in accordance with the process 400 of FIG. 4. Results 510 show a time period of over 40 seconds. For each PCI value received by the UE, the time period associated with that physical cell is also shown. After about 40 seconds pass, the UE determines at time corresponding to entry 512 that the number of changes for the PCI value indicate that a high-mobility mode is occurring. The UE enters a high-mobility mode and immediately changes to LTE mode using the LTE network. The BWP switch timer value is set to 0 seconds for the high-mobility mode.

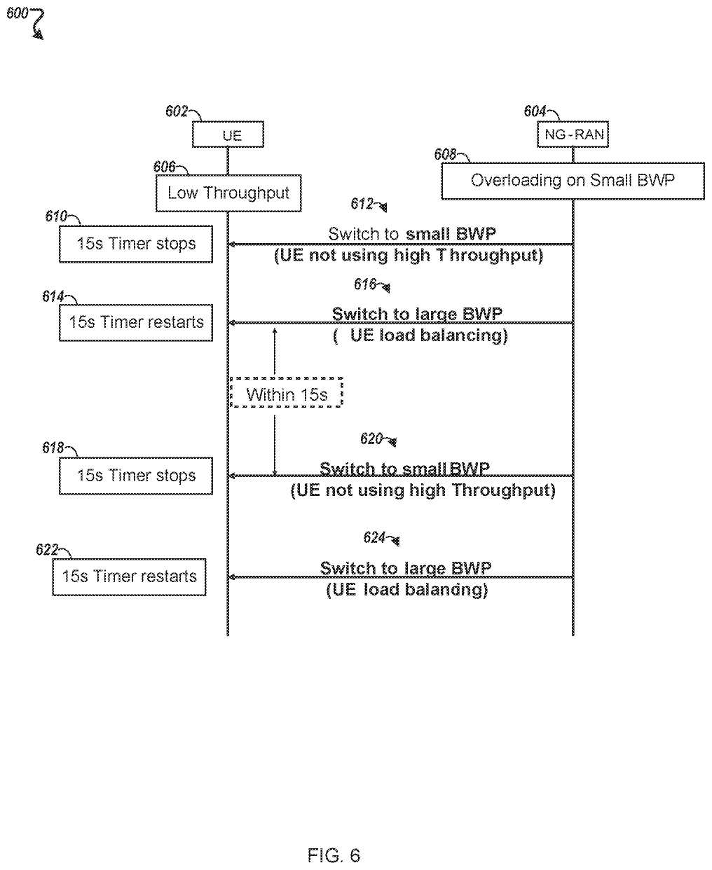

FIG. 6 shows a diagram illustrating a SA switching environment 600 including a UE 602 (e.g., similar to UE 102 of FIG. 1) and network node 604 (e.g., similar to base station 104 of FIG. 1) for BWP load balancing. In this example, the UE is in a low throughput use scenario, but may be overloading the small BWP. In some implementations, the UE will de-priority to LTE as soon as a load balance scenario is detected by the UE. In some implementations, the UE that is not using the high-throughput BWP may ping pong between the large BWP and small BWP for load balancing. The network switches the UE from large BWP to small BWP because the UE does not use the high throughput. The UE saves power by switching to the small BWP. In some implementations, the network switches the UE from the small BWP to the large BWP because a service capability of the small BWP is exceeded. The switch of the UE to the large BWP controls a load balance in the network. The UE stops the BWP switch timer when switching from the large BWP to the small BWP. The UE restarts the BWP switch timer when switching from the small BWP to the large BWP. For a scenario in which the UE is highly mobile (e.g., a high speed train), many users stay on the same cells (e.g., on the small BWP) which triggers a load balancing process by the network. The UE is switched to the large BWP from the small BWP, even though the UE is only using the low throughput service. In another example, in densely populated areas (e.g., a mall in a city), the UE may inadvertently stay on an overloading cell and does not switch to the small BWP to save power. To overcome this, the UE is configured to deprioritize to LTE when the NW load balance process is initiated.

The environment 600 shows the UE 602 interactions with the base station 604 configured for load balancing. The UE 602 is using a low-throughout service 606. The base station 604 determines that overloading is occurring on the small BWP 608. The base station sends an instruction 612 for the UE 602 to switch to the small BWP, though the UE is not using a high throughput service. The UE 602 receives the instruction 612 and resets the BWP switch timer 610. To load balance the BWP, the network 604 sends an instruction 616 to switch the UE 602 to the large BWP. The UE 602 receives the instruction 616 and resets the BWP switch timer 614. Because UE 602 has reset the BWP switch timer with instructions 610 and 614, the BWP switch timer does not expire, and the UE 602 does not switch to the LTE mode. If the network 604 sends another instruction 620 to switch the UE 602 to the small BWP before the BWP switch timer expires (e.g., within 15 seconds), the UE again resets 618 the BWP switch timer. The network 604 again sends an instruction 624 for the UE 602 to switch to the large BWP for load balancing. The UE 602 again resets 622 the switch timer. Because the UE 602 is in a load-balancing scenario, the UE 602 cannot deprioritize to the LTE mode using the LTE network unless the BWP switch timer is adjusted when the UE detects a load balancing mode.

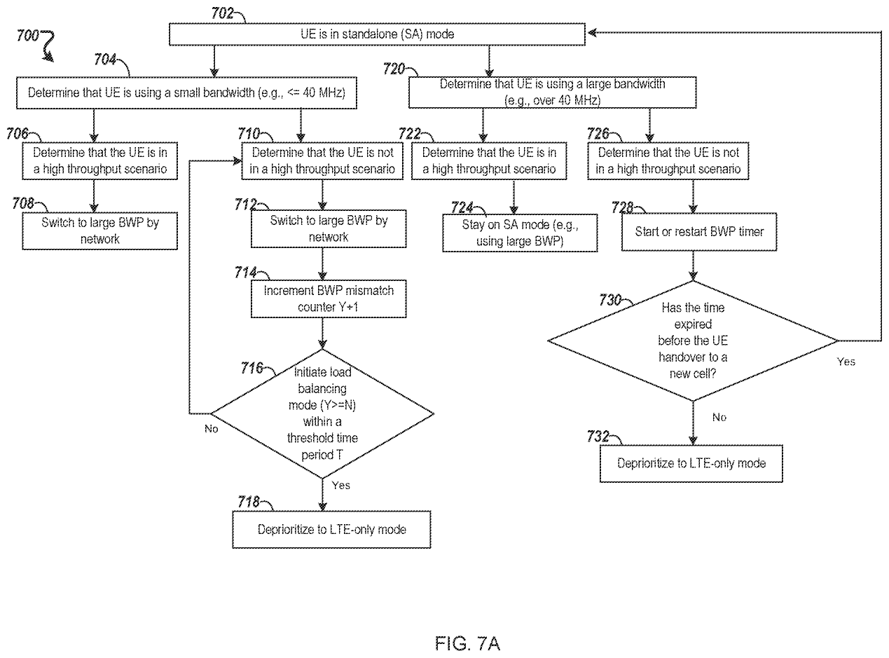

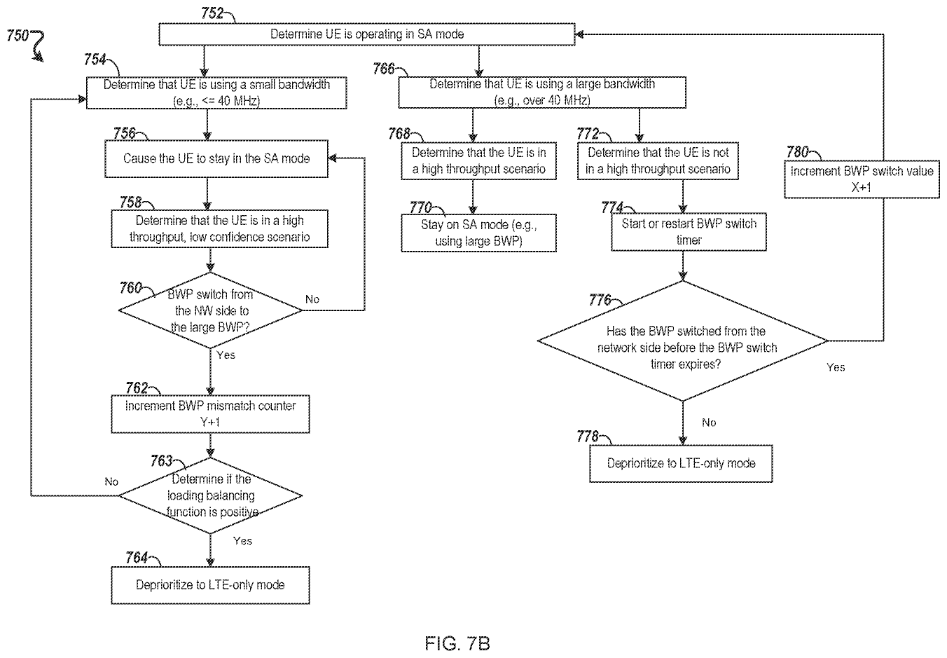

FIG. 7A shows a flow diagram illustrating a process 700 for SA switching by a UE (e.g., UE 102 of FIG. 1 and/or UE 602 of FIG. 6) responsive to BWP load balancing by a network (e.g., base station 104 of FIG. 1 or node 604 of FIG. 6). For performing process 700, the UE detects that the network is load balancing the UE on the network. The UE is operating (702) in the SA mode. The UE is configured to determine whether to change from the SA mode to the LTE mode based on current bandwidth. In a first case, the UE determines (704) that the FR1 or FR2 bandwidth is less than or equal to a particular threshold. For example, the bandwidth threshold can be 20 megahertz (MHz), 25 MHz . . . 40 MHz, or similar values. If the bandwidth is less than or equal to the threshold value, the UE determines whether the UE is operating in a high throughput mode or a low throughput mode. If the UE determines (706) that the UE operating in a high throughput mode, the UE is configured to perform (708) a BWP switch to the large BWP, as instructed by the network for load balancing. If the UE determines (710) that the UE is operating in a low throughput mode, the UE switches (712) to the large BWP as instructed by the network for load balancing. The UE maintains a counter value (shown as Y in FIG. 6). The counter value Y represents a number of unexpected instructions for a BWP switch from the small BWP to the large BWP. In this example, an unexpected instruction represents an instruction that is not included in nominal network behavior (e.g., instructions representative of abnormal network behavior). Responsive to receiving each instance of the instruction from the network to switch from the small BWP to the large BWP, the UE increments (714) the value of the counter. When the counter value exceeds a threshold value N within an evaluation period of time T, the UE determines (716) that the network is performing load balancing for the UE. The value of N is configurable by the UE based on a heuristic process. When the UE determines that the network is performing load balancing, the UE is configured to deprioritize (718) and switch from the SA mode to the LTE mode using the LTE network.

In some implementations, the UE determines (720) that the UE is operating using the large BWP. For example, the UE determines, in the SA mode, that the FR1/FR2 bandwidth is above the threshold value (e.g., 40 MHz). If the UE determines (722) that the UE operating in a high throughput mode, the UE remains (724) in the SA mode using the large BWP. If the UE determines (726) that the UE is not using a high-throughput service or is not in a high-throughput mode, the UE is configured to start or restart (728) a BWP switch timer (e.g., at 15 seconds). The UE determines (730) whether to stay in the SA mode or switch to the LTE mode. If the network switches the to the small BWP by the network before the UE switch timer expires or the UE is handed to a new cell by the network, the UE does not switch to the LTE network and instead stays on the SA mode. The UE tests for a load-balancing scenario again (e.g., by returning to step 702). If the BWP switch timer expires, the UE switches (732) to LTE mode and uses the LTE network.

Generally, for process 700, the threshold value N of the load-balancing counter is configurable. The value of N can be adjusted based on machine learning models or can be trained using data gathered from many instances of load balancing of UEs by the network. Generally, the network supports BWP switching by the UE and the network configures multiple BWP for each UE.

FIG. 7B shows a flow diagram illustrating a process 750 for SA switching by a UE (e.g., UE 102 of FIG. 1) for BWP load balancing. The loading balance mode is triggered for switching from the small BWP to the large BWP. Generally, the loading balance mode is not triggered for a BWP switch from the large BWP to the small BWP, even when there is not a high throughput scenario. Generally, the loading balance mode occurs for a BWP switch between large and small BWPs and when the UE is at a low throughput. For the loading balance mode of process 750, the network supports BWP switching, the network has configured multiple BWPs to the UE. In this process 750 and for Table 2 below, X represents a number of BWP switches that occur from the large BWP to the small BWP. Y represents a number of BWP switches from the small BWP to the large BWP. T represents a length (e.g., in seconds) for an evaluation time period. When a function of X, Y, and T, is positive (e.g., F(X, Y, T)>0), the UE is configured to enter the loading balance mode. Generally, the function F(X, Y, T) is dynamic, and evaluates the BWP switch frequency in T.

The process 750 includes determining a BWP used by the UE when the UE is (752) in standalone mode. In the process, 750, if the UE is using (754) a small BWP (e.g., less than or equal to 40 MHz), the UE stays (756) in the SA mode. The process 750 includes determining (758) that the UE is in a high-throughput, low-confidence scenario. The process 750 includes determining (760) if the network has switched the UE from the small BWP to a large BWP. If no switch has occurred, the UE is caused to stay (756) in the SA mode. If the NW has switched the BWP for the UE, the process 750 includes incrementing (762) a BWP mismatch counter value Y is incremented. The process 750 includes determining (763) if a load balancing function F(X, Y, T) is positive (e.g., >0). If the function is positive, the process 750 includes switching the UE to LTE mode (e.g., deprioritizing the UE to LTE). If the load balancing function F(X, Y, T) is not positive, the process 750 monitors the BWP for the UE (at step 754).

During the process, the UE can be using the large BWP (e.g., over 40 MHz). If the UE is determined (766) to be on the large BWP, the process 750 includes determining (768, 772) whether the UE is in a high throughput scenario or a low throughput scenario. If the UE is in a high throughput scenario, the UE is configured to stay (770) on the SA mode (e.g., using the large BWP). If the UE is not in the high throughput scenario, the process 750 includes starting or restarting (774) the BWP switch timer of the UE. The process 750 includes monitoring the UE to determine (776) if the BWP for the UE has switched from the network side before the BWP switch timer has expired. If the NW has switched the BWP for the UE, the BWP switch value X increments (780). If the NW has not switched the BWP for the UE, the UE deprioritizes to the LTE mode (e.g., switches to LTE).

Table 2 shows example values for T, X, Y, and the F (X, Y, T), and the resulting actions performed by the UE. The UE is operating in a non-load balancing mode when F (X, Y, T) is non-positive. For example, if no BWP switching occurs, and if the switch timer expires, the UE operates in a normal mode. If there is an unexpected switch from the large BWP (BWP 2) to the small BWP (BWP 1), the UE enters the loading balance mode. Additionally, if there is an unexpected switch by the network between the large and small BWPs, the UE enters the loading balance mode.

TABLE 2
Scenarios for the loading balance mode for the UE.

| Cell mode | T | X | Y | F(X, Y, T) | Comments |
|---|---|---|---|---|---|
| Normal mode | 15 | 0 | 0 | 0 | No action |
| Normal mode | 15 | 1 | 0 | 0 | Current BWP with |
| | | | | | 15 timer covered |
| Loading balance | 15 | 0 | 1 | 1 | Unexpected from |
| mode | | | | | BWP#2 toBWP#1 |
| Loading balance | 15 | >=1 | >1 | 1 | Unexpected between |
| mode | | | | | BWP#2 and BWP#1 |

The example processes 300, 350, 400, 700, and 750 shown in FIGS. 3A, 3B, 4, 7A, and 7B can be modified or reconfigured to include additional, fewer, or different steps (not shown in FIGS. 3A-3B, 4, or 7A-7B), which can be performed in the order shown or in a different order.

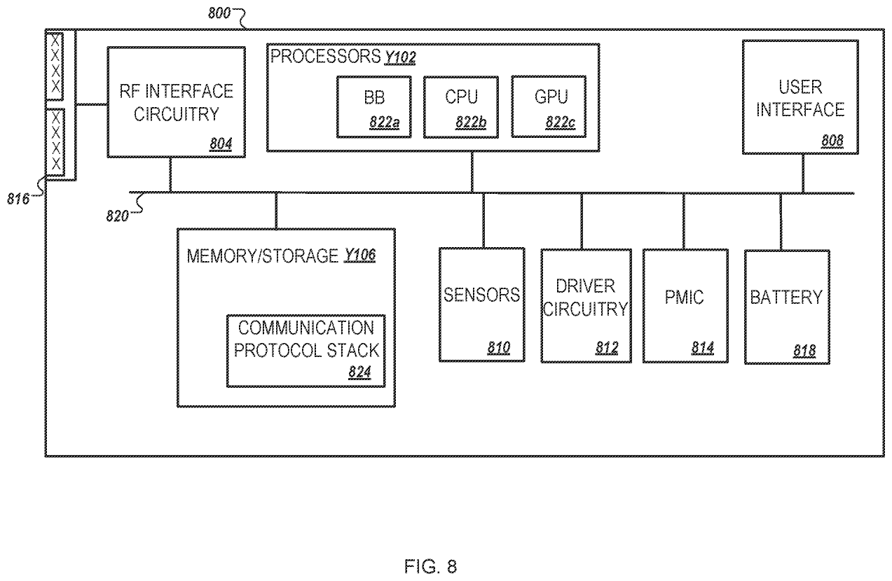

FIG. 8 illustrates a UE 800, in accordance with some embodiments. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, antenna structure 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some embodiments, the baseband processor circuitry 822A may access a communication protocol stack 824 in the memory/storage 806 to communicate over a 3GPP compatible network. In general, the baseband processor circuitry 822A may access the communication protocol stack to perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 804. The baseband processor circuitry 822A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some embodiments, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816.

In various embodiments, the RF interface circuitry 804 may be configured to transmit/receive signals in a manner compatible with NR access technologies.

The antenna 816 may include antenna elements to convert electrical signals into radio waves to travel through the air and to convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensor circuitry 828 and control and allow access to sensor circuitry 828, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some embodiments, the PMIC 814 may control, or otherwise be part of, various power saving mechanisms of the UE 800 including DRX as discussed herein. A battery 818 may power the UE 800, although in some examples the UE 800 may be mounted deployed in a fixed location and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

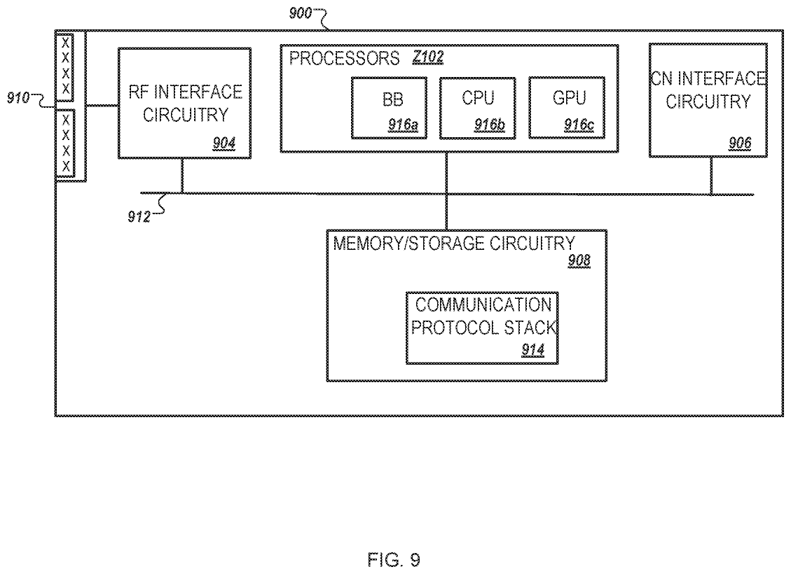

FIG. 9 illustrates an access node 900 (e.g., a base station or gNB), in accordance with some embodiments. The access node 900 may be similar to and substantially interchangeable with base station 104. The access node 900 may include processors 902, RF interface circuitry 904, core network (CN) interface circuitry 906, memory/storage circuitry 908, and antenna structure 910.

The components of the access node 900 may be coupled with various other components over one or more interconnects 912. The processors 902, RF interface circuitry 904, memory/storage circuitry 908 (including communication protocol stack 914), antenna structure 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various embodiments, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 900 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 900; a MAC/PHY split wherein RRC, PDCP, RLC, and MAC layers are operated by the CRAN/vBBUP and the PHY layer is operated by the access node 900; or a “lower PHY” split wherein RRC, PDCP, RLC, MAC layers and upper portions of the PHY layer are operated by the CRAN/vBBUP and lower portions of the PHY layer are operated by the access node 900.

In V2X scenarios, the access node 900 may be or act as RSUs. The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method having operations including: determining that a user equipment (UE) is connected to a cell of a network using a connection in a standalone (SA) mode; determining a bandwidth part (BWP) of the connection; based on determining the BWP of the connection, accessing a physical cell identifier (PCI) list associated with the UE for a time period, the PCI list comprising a number of PCI values; comparing the number of PCI values to a threshold number; based on the comparison and a duration of the time period, assigning, to a BWP switch timer, a timeout value; initiate the BWP switch timer; in response to determining that the BWP switch timer has reached the timeout value without a handover of the UE to a different cell of the network, causing the UE to continue to operate using the SA mode; and in response to determining that the handover of the UE to the different cell of the network occurs prior to the BWP switch timer reaching the timeout value, causing the UE to switch to a LTE mode (e.g., LTE).

Example 2 may include the operations of example 1, wherein comparing the number of PCI values to a threshold number comprises: in response to determining that the number of PCI values equals or exceeds the threshold number, assigning a timeout value to the BWP switch timer based on a ratio of the number of PCI values to the duration of the time period in seconds.

Example 3 may include the operations of example 1 or 2, wherein comparing the number of PCI values to a threshold number comprises: in response to determining that the number of PCI values does not equal or exceeds the threshold number, assigning a standard timeout value to the BWP switch timer.

Example 4 may include the operations of example 1-3, wherein the standard timeout value is 15 seconds.

Example 5 may include the operations of example 1-4, further including determining that the UE is in a high throughput scenario or a high-confidence scenario; and responsive to determining that the UE is in a high throughput scenario or high-confidence scenario, causing the UE to continue operating in the SA mode.

Example 6 may include the operations of example 1-5, further including determining that the UE is in a low throughput scenario or a low-confidence scenario; and responsive to the determining, performing the accessing of the PCI list.

Example 7 may include the operations of example 1-6, wherein determining the bandwidth part (BWP) of the connection comprises determining that the UE is connected using a small BWP or a large BWP.

Example 8 may include the operations of example 7, wherein the large BWP is larger than 40 MHz, and wherein the small BWP is less than or equal to 40 MHz.

Example 9 may include the operations of example 7, further comprising: responsive to determining that the UE is connected using a small BWP, causing the UE to continue operating in the SA mode.

Example 10 may include the operations of example 9, further comprising: determining that the UE is in a high throughput scenario; detecting an instruction to switch from the small BWP to the large BWP; incrementing a BWP mismatch counter; determining if a loading balancing function is positive, the loading balancing function being based on the BWP mismatch counter; in response to determining that the loading balancing function is positive, switching the UE to operate in the LTE mode; and in response to determining that the loading balancing function is not positive, causing the UE to continue operating using the SA mode.

Example 11 may include the operations of examples 7-10, further comprising: responsive to determining that the UE is connected using a large BWP, determining that the UE is not in a high-throughput scenario; based on the determining, starting or restarting the BWP switch timer; in response to determining that the BWP switch timer has reached the timeout value without a handover of the UE to a different cell of the network, causing the UE to continue to operate using the SA mode; and in response to determining that the handover of the UE to the different cell of the network occurs prior to the BWP switch timer reaching the timeout value, causing the UE to switch to LTE.

Example 12 may include the operations of examples 1-11, wherein, while operating in the SA mode, the UE is configured to use a new radio (NR) network for transmission and reception of control data and user data, and wherein, while operating in the LTE mode, the UE is configured to use a long term evolution (LTE) network for transmission and reception of control information, and the NR network for transmission and reception of user data.

Example 13 may include the operations of examples 1-12, wherein the connection is a radio resource control (RRC) configured connection.

Example 14 may include one or more non-transitory computer-readable media including instructions to cause an electronic device, upon execution of the instructions by one or more processors of the electronic device, to perform one or more elements of a method described in or related to any of examples 1-13, or any other method or process described herein.

Example 15 may include an apparatus including logic, modules, or circuitry to perform one or more elements of a method described in or related to any of examples 1-13, or any other method or process described herein.

Example 16 may include a method, technique, or process as described in or related to any of examples 1-13, or portions or parts thereof

Example 17 may include an apparatus including: one or more processors and one or more computer-readable media including instructions that, when executed by the one or more processors, cause the one or more processors to perform the method, techniques, or process as described in or related to any of examples 1-13, or portions thereof

Example 18 may include a signal as described in or related to any of examples 1-13, or portions or parts thereof

Example 19 may include a datagram, information element, packet, frame, segment, PDU, or message as described in or related to any of examples 1-13, or portions or parts thereof, or otherwise described in the present disclosure.

Example 20 may include a signal encoded with data as described in or related to any of examples 1-13, or portions or parts thereof, or otherwise described in the present disclosure.

Example 21 may include a signal encoded with a datagram, TE, packet, frame, segment, PDU, or message as described in or related to any of examples 1-13, or portions or parts thereof, or otherwise described in the present disclosure.

Example 22 may include an electromagnetic signal carrying computer-readable instructions, wherein execution of the computer-readable instructions by one or more processors is to cause the one or more processors to perform the method, techniques, or process as described in or related to any of examples 1-13, or portions thereof

Example 23 may include a computer program including instructions, wherein execution of the program by a processing element is to cause the processing element to carry out the method, techniques, or process as described in or related to any of examples 1-13, or portions thereof. The operations or actions performed by the instructions executed by the processing element can include the methods of any one of examples 1-13.

Example 24 may include a signal in a wireless network as shown and described herein.

Example 25 may include a method of communicating in a wireless network as shown and described herein.

Example 26 may include a system for providing wireless communication as shown and described herein. The operations or actions performed by the system can include the methods of any one of examples 1-13.

Example 27 may include a device for providing wireless communication as shown and described herein. The operations or actions performed by the device can include the methods of any one of examples 1-13.

The previously described examples 1-13 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-13.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
determining that a user equipment (UE) is connected to a cell of a network using a connection in a standalone (SA) mode;
determining a bandwidth part (BWP) of the connection;
based on determining the BWP of the connection, accessing a physical cell identifier (PCI) list associated with the UE for a time period, the PCI list comprising a number of PCI values;
comparing the number of PCI values to a threshold number;
based on the comparing and based on a duration of the time period, assigning, to a BWP switch timer, a timeout value;
initiating the BWP switch timer;
in response to determining that the BWP switch timer has reached the timeout value without a handover of the UE to a different cell of the network, causing the UE to switch to Long Term Evolution (LTE) mode and using LTE network; and
in response to determining that the handover of the UE to the different cell of the network occurs prior to the BWP switch timer reaching the timeout value, causing the UE to continue to operate using the SA mode.

2. The method of claim 1, wherein comparing the number of PCI values to a threshold number comprises:
in response to determining that the number of PCI values equals or exceeds the threshold number, assigning a timeout value to the BWP switch timer based on a ratio of the number of PCI values to the duration of the time period in seconds.

3. The method of claim 1, wherein comparing the number of PCI values to a threshold number comprises:
in response to determining that the number of PCI values does not equal or exceeds the threshold number, assigning a standard timeout value to the BWP switch timer.

4. The method of claim 3, wherein the standard timeout value is 15 seconds.

5. The method of claim 1, further comprising:
determining that the UE is in a high throughput scenario or a high-confidence scenario; and
responsive to determining that the UE is in a high throughput scenario or high-confidence scenario, causing the UE to continue operating in the SA mode.

6. The method of claim 1, further comprising:
determining that the UE is in a low throughput scenario or a low-confidence scenario; and
responsive to the determining, performing the accessing of the PCI list.

7. The method of claim 1, wherein determining the bandwidth part (BWP) of the connection comprises determining that the UE is connected using a small BWP or a large BWP.

8. The method of claim 7, wherein the large BWP is larger than 40 Megahertz (MHz), and wherein the small BWP is less than or equal to 40 MHz.

9. The method of claim 7, further comprising:
responsive to determining that the UE is connected using a small BWP, causing the UE to continue operating in the SA mode.

10. The method of claim 9, further comprising:
determining that the UE is in a high throughput scenario;
detecting an instruction to switch from the small BWP to the large BWP;
incrementing a BWP mismatch counter;
determining if a loading balancing function is positive, the loading balancing function being based on the BWP mismatch counter;
in response to determining that the loading balancing function is positive, switching the UE to operate in the LTE mode; and
in response to determining that the loading balancing function is not positive, causing the UE to continue operating using the SA mode.

11. The method of claim 7, further comprising:
responsive to determining that the UE is connected using a large BWP, determining that the UE is not in a high-throughput scenario;
based on the determining, starting or restarting the BWP switch timer;
in response to determining that the BWP switch timer has reached the timeout value without a handover of the UE to a different cell of the network, causing the UE to switch to LTE mode and using LTE network; and
in response to determining that the handover of the UE to the different cell of the network occurs prior to the BWP switch timer reaching the timeout value, causing the UE to continue to operate using the SA mode.

12. The method of claim 1, wherein, while operating in the SA mode, the UE is configured to use a new radio (NR) network for transmission and reception of control data and user data, and wherein, while operating in the LTE mode, the UE is configured to use a long term evolution (LTE) network for transmission and reception of control information and user data.

13. The method of claim 12, wherein the connection is a radio resource control (RRC) configured connection.

14. A system comprising one or more computing unit and one or more storage units on which are stored instructions that are operable, when executed by the system, to perform operations comprising:
determining that a user equipment (UE) is connected to a cell of a network using a connection in a standalone (SA) mode;
determining a bandwidth part (BWP) of the connection;
based on determining the BWP of the connection, accessing a physical cell identifier (PCI) list associated with the UE for a time period, the PCI list comprising a number of PCI values;
comparing the number of PCI values to a threshold number;
based on the comparing and based on a duration of the time period, assigning, to a BWP switch timer, a timeout value;
initiating the BWP switch timer;
in response to determining that the BWP switch timer has reached the timeout value without a handover of the UE to a different cell of the network, causing the UE to switch to LTE network; and
in response to determining that the handover of the UE to the different cell of the network occurs prior to the BWP switch timer reaching the timeout value, causing the UE to continue to operate using the SA mode.

15. The system of claim 14, wherein comparing the number of PCI values to a threshold number comprises:
in response to determining that the number of PCI values equals or exceeds the threshold number, assigning a timeout value to the BWP switch timer based on a ratio of the number of PCI values to the duration of the time period in seconds.

16. The system of claim 14, wherein comparing the number of PCI values to a threshold number comprises:
in response to determining that the number of PCI values does not equal or exceeds the threshold number, assigning a standard timeout value to the BWP switch timer.

17. One or more processors of a first user equipment (UE), the one or more processors configured to cause the first UE to perform operations comprising:
determining that a user equipment (UE) is connected to a cell of a network using a connection in a standalone (SA) mode;
determining a bandwidth part (BWP) of the connection;
based on determining the BWP of the connection, accessing a physical cell identifier (PCI) list associated with the UE for a time period, the PCI list comprising a number of PCI values;
comparing the number of PCI values to a threshold number;
based on the comparing and based on a duration of the time period, assigning, to a BWP switch timer, a timeout value;
initiating the BWP switch timer;
in response to determining that the BWP switch timer has reached the timeout value without a handover of the UE to a different cell of the network, causing the UE to switch to Long Term Evolution (LTE) mode and using LTE network; and
in response to determining that the handover of the UE to the different cell of the network occurs prior to the BWP switch timer reaching the timeout value, causing the UE to continue to operate using the SA mode.

18. The one or more processors of claim 17, wherein comparing the number of PCI values to a threshold number comprises:
in response to determining that the number of PCI values equals or exceeds the threshold number, assigning a timeout value to the BWP switch timer based on a ratio of the number of PCI values to the duration of the time period in seconds.

19. The one or more processors of claim 17, wherein comparing the number of PCI values to a threshold number comprises:
in response to determining that the number of PCI values does not equal or exceeds the threshold number, assigning a standard timeout value to the BWP switch timer.

20. The one or more processors of claim 17, the operations further comprising:
determining that the UE is in a high throughput scenario or a high-confidence scenario; and
responsive to determining that the UE is in a high throughput scenario or high-confidence scenario, causing the UE to continue operating in the SA mode.
